(19) United States
(12) Patent Application Publication
(10) Pub. No.: US 2015/0051278 A1
(43) Pub. Date: Feb. 19, 2015

(54) METHOD OF EXTERMINATING HARMFUL INSECT

(71) Applicant: KAO CORPORATION, Tokyo (JP)

(72) Inventor: Masatoshi Kamei, Wakayama-shi (JP)

(21) Appl. No.: 14/382,214

(22) PCT Filed: Feb. 25, 2013
(86) PCT No.: PCT/JP2013/054644

§ 371 Date: Aug. 29, 2014

(30) Foreign Application Priority Data
Mar. 6, 2012 (JP) 2012-049194
Mar. 6, 2012 (JP) 2012-049195

(51) Int. Cl. A01N 37/36; A01N 43/08; A01N 43/16; A01N 31/02

(52) U.S. Cl. CPC A01N 37/36; A01N 31/02; A01N 43/08; A01N 43/16
USPC 514/473; 514/552

(57) ABSTRACT

The invention is a method of exterminating a harmful insect with an agricultural and horticultural insecticide containing one or more kinds of compound (A) selected from a specific polyoxyethylene fatty acid ester, a specific polyoxyethylene sorbitan fatty acid ester, a specific (poly)glycerol fatty acid ester, and a specific alkyl saccharide, and a compound (B) of an alcohol having a linear or branched alkyl group having 8 to 14 carbon atoms or a linear or branched alkyl ether having 6 to 12 carbon atoms, provided that an agricultural chemical ingredient of an agricultural chemical is not substantially contained.

### FIELD OF THE INVENTION

The present invention relates to an agricultural and horticultural insecticide and a method of exterminating a harmful insect. Meanwhile, in the invention, the harmful insect includes an insect such as aphid and then a mite for convenience.

### BACKGROUND OF THE INVENTION

Harmful insects cause not only growth inhibition and deterioration in quality of crops and garden plants by sapping and settling therein, but also cause a great damage to plants by carrying viruses. Currently, chemically synthesized agricultural chemicals such as organophosphorus insecticides, carbamate insecticides, and pyrethroid insecticides are used for the extermination of harmful insects. However, breeding of harmful insects can be suppressed, but propagation of virus cannot be sufficiently prevented by these agricultural chemicals. In addition, there are also cases in which it is desired to repel harmful insects without resorting to these agricultural chemicals and to reduce the amount of agricultural chemicals used in consideration of environmental load. Moreover, there is also a problem that drug resistance is developed in harmful insects by excessive spraying of agricultural chemicals. In addition, worker's safety or a remaining property onto agricultural products is also concerned.

Hitherto, studies on agents for repelling plant harmful insects have been conducted, and, for example, it is known that a sorbitan fatty acid ester is used as an agricultural and horticultural harmful insect repellent (JP-A 2007-326832). In addition, it is known that a specific plant extract or an agricultural chemical is used as a mite repellent (JP-A 2000-302620, JP-A 2001-158711, and JP-A 2005-179328). In addition, it is known a physically based pesticide, capable of exterminating harmful insects without using a chemical agricultural chemical such as an agricultural and horticultural insecticide or controller with a fatty acid glyceride (JP-A 63-233902), a mite control composition containing propylene glycol monofatty acid ester and a nonionic surfactant (JP-A 10-251104), and a noxious organism control composition containing starch and a nonionic surfactant (JP-A 11-343201).

WO-A 2012/029893 distributed on Mar. 8, 2012 discloses a method for producing crops, in which an effect-enhancing agent for an agricultural chemical and an agricultural chemical ingredient of an agricultural chemical are used.

### SUMMARY OF THE INVENTION

The invention is a method of exterminating a harmful insect, including applying an agricultural and horticultural insecticide containing one or more kinds of compound (A) [hereinafter, referred to as the compound (A)] selected from the following (A1) to (A4)and one or more kinds of compound (B) [hereinafter, referred to as the compound (B)] selected from the following (B1) and (B2), provided that an agricultural chemical ingredient of an agricultural chemical is not substantially contained, to a harmful insect or a plant,
wherein

the agricultural chemical ingredient of an agricultural chemical is selected from agricultural chemical ingredients of a germicide, an insecticide, an acaricide, a herbicide and a plant growth regulator;

(A1): a polyoxyethylene fatty acid ester, provided that the carbon number of the fatty acid is 8 to 16 and an average added mole number of ethylene oxide is 5 to 40 [hereinafter, referred to as the compound (A1)];

(A2): a polyoxyethylene sorbitan fatty acid ester, provided that the carbon number of the fatty acid is 8 to 16 and an average added mole number of ethylene oxide is 5 to 40 [hereinafter, referred to as the compound (A2)];

(A3): a (poly)glycerol fatty acid ester, provided that the carbon number of the fatty acid is 8 to 16 and an average condensation degree of glycerol is 1 to 3 [hereinafter, referred to as the compound (A3)]; and

(A4): an alkyl saccharide represented by the following Formula (A4) [hereinafter, referred to as the compound (A4)]:

R^{1a}—O-(G)ₚ (A4)

in Formula (A4), R^{1a} represents an alkyl group having 8 to 16 carbon atoms, G represents a reducing sugar having 5 to 6 carbon atoms, and p is a number of 1 to 10;

(B1): a compound represented by (B1):

R^{1b}—OH (B1)

in Formula (B1), R^{1b} represents a linear or branched alkyl group having 8 to 14 carbon atoms; and

(B2): a compound represented by (B2):

R^{2c}O—[(PO)ₘ/(EO)ₙ]—R^{2b} (B2)

in Formula (B2), R^{2c} represents a linear or branched alkyl or alkenyl group having 6 to 12 carbon atoms, PO represents a propyleneoxy group, EO represents an ethyleneoxy group, m is a number of 1 to 25 representing an average added mole number of propyleneoxy group, n is a number of 0 to 4 representing an average added mole number of ethyleneoxy group, R^{2b} represents a hydrogen atom or a methyl group, and “/” means that arrangement of PO and EO may be random or block.

The invention is a use of an agricultural and horticultural insecticide containing one or more kinds of compound (A) selected from (A1) to (A4) described above and one or more kinds of compound (B) selected from (B1) and (B2) described above but substantially not containing an agricultural chemical ingredient of agricultural chemical to kill a harmful insect, provided that the agricultural chemical ingredient of agricultural chemical is selected from the agricultural chemical ingredient of each of a germicide, an insecticide, an acaricide, a herbicide, and a plant growth regulator.

### DETAILED DESCRIPTION OF THE INVENTION

In the above literatures, an insecticide containing a chemically synthesized agricultural chemical such as an organophosphorous insecticide, a carbamate insecticide, and a pyrethroid insecticide as the main component has been pointed out in the effects on the human body, acquisition of resistance of harmful insect, safety to the environment, and the like. In addition, a physical agent-based insecticide of the related art does not exhibit a sufficient effect for repelling an aphid or a mite and killing an insect, and thus is desired to be further improved.

The invention relates to the agricultural and horticultural insecticide described above. The invention provides an agricultural and horticultural insecticide to which a harmful insect hardly acquires drug resistance and which exhibits an excellent insecticidal effect.

### BRIEF DESCRIPTION OF DRAWINGS

FIG. 1 is a photomicrograph illustrating the spiracle state of cotton aphid of Comparative Example 1 (non-treated area) and Example 1 after insecticidal test II.

The agricultural and horticultural insecticide of the invention (hereinafter, simply referred to as the “insecticide of the invention” in some cases), contains a compound (A) and a compound (B). It is presumed that by concurrently using the compound (A) and the compound (B), the insecticide exhibits an excellent wet spreading property (ease of wetting and spreading) on the body surface of harmful insect, and the spiracle of harmful insect is physically blockaded effectively and thus the harmful insect is put to death. In addition, since the insecticide of the invention puts a harmful insect to death by a physical action of blockading the spiracle, it is considered that the harmful insect hardly acquires drug resistance to the insecticide of the invention compared to a chemically synthesized agricultural chemical.

### <Compound (A)>

The insecticide of the invention contains one or more kinds of compound (A) selected from the following (A1) to (A4) from the viewpoint of the improvement in the wet spreading property on the body surface of harmful insect and in the insecticidal effect. Among the following compounds (A1) to (A4), the compound (A1) and the compound (A3) are preferable and the compound (A3) is more preferable from the viewpoint of the improvement in the wet spreading property on the body surface of harmful insect and in the insecticidal effect.

The compound (A1) is a polyoxyethylene fatty acid ester. The carbon number of the fatty acid in the compound (A1) is 8 to 16, preferably 10 to 14, and more preferably 10 to 12 from the viewpoint of the improvement in the wet spreading property and in the insecticidal effect. The fatty acid in the compound (A1) is a fatty acid having preferably a linear or branched alkyl or alkenyl group and more preferably a linear alkyl group from the viewpoint of the improvement in the wet spreading property and in the insecticidal effect. Examples of the fatty acid in the compound (A1) may include caprylic acid, capric acid, lauric acid, myristic acid, and palmitic acid. In addition, the average added mole number of ethylene oxide in the compound (A1) is 5 to 40, preferably 5 to 20, and more preferably 6 to 15 from the viewpoint of the improvement in the wet spreading property and in the insecticidal effect. In addition, the ester is preferably a monoester.

The compound (A2) is a polyoxyethylene sorbitan fatty acid ester. The carbon number of the fatty acid in the compound (A2) is 8 to 16, preferably 10 to 14, and more preferably 10 to 12 from the viewpoint of the improvement in the wet spreading property and in the insecticidal effect. The fatty acid in the compound (A2) is a fatty acid having preferably a linear or branched alkyl or alkenyl group and more preferably a linear alkyl group from the viewpoint of the improvement in the wet spreading property on the body surface of harmful insect and in the insecticidal effect. Examples of the fatty acid in the compound (A2) may include caprylic acid, capric acid, lauric acid, myristic acid, and palmitic acid. In addition, the average added mole number of ethylene oxide in the compound (A2) is 5 to 40, preferably 5 to 20, and more preferably 6 to 15 from the viewpoint of the improvement in the wet spreading property and in the insecticidal effect. In addition, the degree of esterification is preferably 1.

The compound (A3) is a (poly)glycerol fatty acid ester. Here, the term “(poly)glycerol fatty acid ester” means “one or more kinds selected from a glycerol fatty acid ester and a polyglycerol fatty acid ester”. The carbon number of the fatty acid in the compound (A3) is 8 to 16, preferably 8 to 12, more preferably 10 to 12, and even more preferably 12 from the viewpoint of the improvement in the wet spreading property and in the insecticidal effect. The fatty acid in the compound (A3) is a fatty acid having preferably a linear or branched alkyl or alkenyl group and more preferably a linear alkyl group from the viewpoint of the improvement in the wet spreading property and in the insecticidal effect. Examples of the fatty acid may include caprylic acid, capric acid, lauric acid, myristic acid, and palmitic acid. In addition, the average condensation degree of glycerol in the compound (A3) is 1 to 3, more preferably 1 to 2, and even more preferably 1 from the viewpoint of the improvement in the wet spreading property and in the insecticidal effect. In addition, the form of ester bond is preferably a monoester and a diester, and more preferably a monoester.

The compound (A4) is an alkyl saccharide represented by the following Formula (A4).

R^{1a}—O-(G)ₚ (A4)

in Formula (A4), R^{1a} is an alkyl group having 8 to 16 carbon atoms, preferably an alkyl group having 10 to 14 carbon atoms, more preferably an alkyl group having 10 to 12 carbon atoms, and even more preferably an alkyl group having 12 carbon atoms from the viewpoint of the improvement in the wet spreading property and in the insecticidal effect. G is a reducing sugar having 5 to 6 carbon atoms, for example, ribose, arabinose, xylose, allose, altrose, glucose, mannose, fructose, gulose, idose, galactose, and talose, preferably glucose, mannose, fructose, and galactose, and more preferably glucose from the viewpoint of the improvement in the wet spreading property and in the insecticidal effect. p is a number of 1 to 10, preferably a number of 1 to 5, and more preferably a number of 3 to 5 from the viewpoint of the improvement in the wet spreading property and in the insecticidal effect.

### <Compound (B)>

A compound (B) is a compound (B1) which is represented by Formula (B1) and an alcohol having a linear or branched alkyl group having 8 to 14 carbon atoms, or a compound (B2) which is represented by Formula (B2) and a linear or branched alkyl ether having 6 to 12 carbon atoms.

The compound (B1) is represented by the following Formula (B1).

R^{1b}—OH (B1)

in Formula (B1), R^{1b} is a linear or branched alkyl group having 8 to 14 carbon atoms, preferably a linear or branched alkyl group having 8 to 12 carbon atoms, more preferably a linear or branched alkyl group having 8 to 10 carbon atoms, and even more preferably a linear alkyl group having 10 carbon atoms from the viewpoint of the improvement in the wet spreading property and in the insecticidal effect.

The compound (B2) is represented by the following Formula (B2).

R^{2c}O—[(PO)ₘ/(EO)ₙ]—R^{2b} (B2)

In Formula (B2), R^{2c} is a linear or branched alkyl or alkenyl group having 6 to 12 carbon atoms, preferably a linear or branched alkyl or alkenyl group having 8 to 12 carbon atoms, more preferably a linear or branched alkyl or alkenyl group having 8 to 10 carbon atoms, and even more preferably a linear alkyl group having 8 to 10 carbon atoms from the viewpoint of the improvement in the wet spreading property on the body surface of harmful insect and in the insecticidal effect. In addition, m is the average added mole number of propyleneoxy (PO) group of 1 to 25, preferably 2 to 20, more preferably 2 to 18, even more preferably 2 to 16, even more preferably 2 to 12, and even more preferably 2 to 10 from the viewpoint of the improvement in the wet spreading property on the body surface of harmful insect and in the insecticidal effect. n is the average added mole number of ethyleneoxy (EO) group of 0 to 4, preferably 0 to 3, more preferably 0 to 2, even more preferably 0 to 1, and even more preferably 0 from the viewpoint of the improvement in the wet spreading property on the body surface of harmful insect and in the insecticidal effect. In addition, in the compound (B2), the ratio of m to the sum of m and n in Formula (B2) is preferably 0.5 to 1.0, more preferably 0.6 to 1.0, even more preferably 0.7 to 1.0, even more preferably 0.8 to 1.0, even more preferably 0.9 to 1.0, and even more preferably 1.0 by m/(m+n) from the viewpoint of the improvement in the wet spreading property on the body surface of harmful insect and in the insecticidal effect. In addition, R^{2b} is a hydrogen atom or a methyl group, and preferably a hydrogen atom from the viewpoint of the improvement in the wet spreading property on the body surface of harmful insect and in the insecticidal effect. In addition, in a case in which PO and EO co-exist in the Compound (B2), the arrangement of PO and EO is preferably a block arrangement, and is more preferably a block arrangement in the order of PO.EO to R^{2c}O— from the viewpoint of the improvement in the wet spreading property on the body surface of harmful insect and in the insecticidal effect.

### <Composition of Agricultural and Horticultural Insecticide and the Like>

In the insecticide of the invention, the weight ratio of the compound (A) to the compound (B) is preferably 0.03 to 30, more preferably 0.05 to 20, even more preferably 0.1 to 10, even more preferably 0.1 to 8, even more preferably 0.3 to 8, and even more preferably 0.5 to 2 by (A)/(B). When the weight ratio of (A)/(B) is in the range described above, the wet spreading property on the body surface of harmful insect and the blockading property of the spiracle of harmful insect are improved, and thus a superior insecticidal effect is obtained.

The insecticide of the invention contains the compound (A) and the compound (B) at preferably 5% by weight or more, more preferably 10% by weight or more, even more preferably 20% by weight or more, even more preferably 40% by weight or more, even more preferably 60% by weight or more, even more preferably 80% by weight or more, and even more preferably 90% by weight or more in total from the viewpoint of the improvement in the wet spreading property on the body surface of harmful insect and in the blockading property of the spiracle of harmful insect. The possible upper limit thereof is 100% by weight.

Moreover, in the invention, a surfactant other than the compound (A) and the compound (B) can be concurrently used in the range that does not impair the wet spreading property improvement effect by the compound (A) and the compound (B). Examples of such a surfactant may include a nonionic surfactant, an anionic surfactant, a cationic surfactant, and an amphoteric surfactant, or a mixture thereof other than the compound (A) and the compound (B).

In a case in which a surfactant other than the compound (A) and the compound (B) is concurrently used, the content thereof can be appropriately selected in the range that does not impair the effect by the compound (A) and the compound (B), and the total proportion of the compound (A) and the compound (B) contained in the total surfactant of the insecticide is preferably 50% by weight or more, more preferably 70% by weight or more, and even more preferably 90% by weight or more from the viewpoint of the improvement in the wet spreading property on the body surface of harmful insect and in the blockading property of the spiracle of harmful insect.

Examples of the nonionic surfactant may include a polyoxyethylene alkyl ether, a polyoxyethylene alkylaryl ether, a polyoxyethylene alkylaryl ether formaldehyde condensate, a polyoxyalkylene aryl ether, a polyoxyalkylene alkyl sorbitol ester, a polyoxyalkylene alkyl glycerol ester, a polyoxyalkylene block copolymer, a polyoxyalkylene block copolymer alkyl glycerol ester, a polyoxyalkylene alkyl sulfonamide, a polyoxypropylene block copolymer, a polyoxyethylene alkenyl ether, a polyoxyalkylene alkylphenol, a polyoxyalkylene alkyl polyglycoside, and a mixture of two or more kinds thereof.

Examples of cationic surfactant may include an alkylamine ethylene oxide adduct, an alkylamine propylene oxide adduct, tallow amine ethylene oxide adduct, oleylamine ethylene oxide adduct, soya amine ethylene oxide adduct, cocoamine ethylene oxide adduct, a synthetic alkylamine ethylene oxide adduct, octylamine ethylene oxide adduct, a dialkylamine derivative, and a mixture thereof. Examples of the dialkyl amine derivative may include a dialkyl monomethyl hydroxyethyl ammonium propionate, a dialkyl monomethyl benzalkonium chloride, a dialkyl monomethyl ethyl ammonium ethyl sulfate, a dialkyl monomethyl amine oxide, a dialkyl monomethyl aminocarboxy betaine, and a dialkyl monomethyl hydroxyl sulfobetaine.

As the cationic surfactant, an alkylamine ethylene oxide adduct, an alkylamine propylene oxide adduct, and a dialkyl amine derivative are preferable, and tallow amine ethylene oxide adduct and dilauryl monomethyl benzalkonium chloride are more preferable from the viewpoint of the improvement in the wet spreading property on the body surface of harmful insect and in the blockading property of the spiracle of harmful insect.

Among the anionic surfactants, a typical surfactant can be available in an aqueous solution or in solid state, and examples thereof may include sodium mono- and di-alkyl naphthalene sulfonate, sodium a-olefin sulfonates, a sodium alkane sulfonate, an alkyl sulfosuccinate salt, an alkyl sulfate salt, a polyoxyalkylene alkyl ether sulfate salt, a polyoxyalkylene alkyl aryl ether sulfate salt, a polyoxyalkylene styryl phenyl ether sulfate salt, mono-and di-alkyl benzene sulfonate salts, an alkyl naphthalene sulfonate salt, a formaldehyde condensate of alkyl naphthalene sulfonate, an alkyl diphenyl ether sulfonate salt, an olefinic sulfonate salt, mono- and di-alkyl phosphate salts, polyoxyalkylene mono- and di-alkyl phosphate salts, polyoxyalkylene mono- and di-phenyl ether phosphate salts, polyoxyalkylene mono- and di-alkyl phenyl ether phosphate salts, a polycarboxylate salt, a fatty acid salt, linear and branched alkyl polyoxyalkylene ether acetic acid or a salt thereof, alkenyl polyoxyalkylene ether acetic acid or a salt thereof, linear and branched alkyl amide polyoxyalkylene ether acetic acids or a salt thereof, stearic acid and a salt thereof, oleic acid and a salt thereof, N-methyl fatty acid taurides, and a mixture (including sodium, potassium, ammonium and amine salts) of two or more kinds thereof. As the anionic surfactant, a fatty acid salt is preferable, sodium and potassium salts of a higher fatty acid such as oleic acid and castor oil fatty acid are more preferable, and potassium oleate is even more preferable from the viewpoint of the improvement in emulsification dispersibility.

In addition, examples of the amphoteric surfactant may include lauryl dimethyl amine oxide, Armox C/12, amine oxide, Monaterics, Miranols, betaine, Lonzaines, another amine oxide, and a mixture thereof.

The insecticide of the invention includes the compound (A) and the compound (B). It is also possible to contain a component other than the compound (A) and the compound (B). The component other than the compound (A) and the compound (B) is preferably water and/or an organic solvent. The insecticide containing water and/or an organic solvent may be an insecticide composition, and the composition is excellent in low temperature stability or high temperature stability and further in long term-storage stability. In addition, since the dispersion and dissolution of the compound (A) and the compound (B) in a diluting medium (water or an organic solvent) is facilitated at the time of dilution in an insecticide containing water or an organic solvent, the insecticidal effect can be increased. Preferred examples of the organic solvent may include isobutanol, isopropanol, ethanol, diethylene glycol, ethyl lactate, butyl cellosolve, polyethylene glycol (weight average molecular weight of 200 to 400), dimethyl sulfoxide, N-butyl carbitol, 1,3-butylene glycol, dipropylene glycol 2-(2-methoxyethoxy) ethanol, and ethyl carbitol. Ethyl lactate, diethylene glycol, and diethylene glycol are preferable from the viewpoint of the improvement in the wet spreading property on the body surface of harmful insect and in the insecticidal effect.

The content of the water and/or the organic solvent contained in the insecticide of the invention is not particularly limited, but the water and/or the organic solvent is preferably used in the amount in which the compound (A) and the compound (B) contained in the insecticide become preferably 50% by weight or more, more preferably 70% by weight or more, and even more preferably 90% by weight or more. The content of the water and/or the organic solvent is preferably less than 50% by weight, for example, from 1 to 50% by weight and further from 5 to 30% by weight in the insecticide.

The insecticide of the invention does not substantially contain an agricultural chemical ingredient of agricultural chemical [a substance which does not correspond to the compound (A) and the compound (B)] from the viewpoint of the reduction of load on the natural environment and of production cost. Here, the agricultural chemical ingredient of agricultural chemical refers to an agricultural chemical ingredient of agricultural chemical.

Examples of the insecticide of the invention may include an insecticide which does not contain any agricultural chemical ingredient of agricultural chemical selected from the agricultural chemical ingredient of each of a germicide, an insecticide, an acaricide, a herbicide, and a plant growth regulator. Furthermore, the insecticide of the invention is preferably an insecticide, which does not contain any agricultural chemical ingredient of agricultural chemical selected from the agricultural chemical ingredient of each of an insecticide and an acaricide, and more preferably an insecticide, which does not contain any component other than the compound (A), the compound (B), and water and/or an organic solvent. An example of the invention may include an insecticide containing the compound (A) and the compound (B). In addition, another example of the invention may include an insecticide containing the compound (A), the compound (B), and water and/or an organic solvent. Meanwhile, in consideration of effect on the plant, the insecticide of the invention preferably has a small content of one or more kinds of compounds selected from (i) hydrogen peroxide and a compound that releases hydrogen peroxide in water and (ii) hypochlorous acid, a hypochlorite salt and a compound that releases hypochlorous acid in water, for example, 0.1% by weight or less or further 0.01% by weight or less, as hypochlorous acid or hydrogen peroxide in the insecticide and it is more preferable that the insecticide has no content.

Examples of the insecticide may include a pyrethroid insecticide such as Permethrin ((3-phenoxybenzyl=(1RS,3RS)-(1RS,3RS)-3-(2,2-dichlorovinyl)-2,2-dimethylcyclopropane carboxylate) and Shiberumetorin ((RS)-α-cyano-3-phenoxybenzyl=1RS,3RS)-(1RS,3RS)-3-(2,2-dichlorovinyl)-2,2-dimethylcyclopropane carboxylate), an organophosphorus insecticide such as CYAP (O,O-dimethyl-O-p-cyanophenyl=thiophosphate), DMTP (O,O-dimethyl-S[5-methoxy-1,3,4-thiadiazol-2(3H)onyl-(3)-methyl]dithiophosphate), BRP (dimethyl-1,2-dibromo-2,2-dichloroethyl phosphate), Salithion (2-methoxy-4H-1,3,2-benzodioxaphosphorin-2-sulfide), and DDVP (dimethyl 2,2-dichlorovinyl phosphate), and a carbamate insecticide such as Bassa (O-sec-butylphenylmethyl carbamate), MTMC (m-tolyl methyl carbamate), Meoperl(3,4-dimethylphenyl N-methylcarbamate), NAC (1-naphthyl N-methylcarbamate), and Methomyl (S-methyl-N[(methylcarbamoyl)oxy]thioacetimide). Furthermore, examples of the insecticide that is not substantially contained in the method of the invention may include an insecticide selected from Permethrin, DDVP (dimethyl 2,2-dichlorovinyl phosphate), and Methomyl (S-methyl-N[(methylcarbamoyl)oxy]thioacetimide).

Moreover, examples of the natural insecticide may include pyrethrin agent derived from pyrethrum, piperonyl butoxide agent, rotenone agent derived from shrub derris of Fabaceae family, and nicotinic agent (3-(1-methyl-2-pyrrolidinyl)pyridine sulfate). Examples of the insect growth regulator (IGR agent) may include Diflubenzuron (1-(4-chlorophenyl)-3-(2,6-difluorobenzoyl)urea) and Teflubenzuron (1-(3,5-dichloro-2,4-difluorophenyl)-3-(2,6-difluoro-benzoyl)urea).

In addition, examples of the acaricide may include CPCBS (p-chlorophenyl-p-chlorobenzene sulfonate), Phenisobromolate (isopropyl 4,4′-dibromobenzilate), Tetradifon (2,4,5,4′-tetrachlorodiphenyl sulfone), Fenothiocarb (S-4-phenoxybutyl=dimethyl thiocarbamate), Fenpyroximate (tert-butyl=(E)-α-(1,3-dimethyl-5-phenoxypyrazol-4-ylmethyleneaminooxy)-p-toluate), and Amitraz (3-methyl-1,5-bis(2,4-xylyl)-1,3,5-triazapenta-1,4-diene). Furthermore, examples of the acaricide that is preferably not contained in the insecticide of the invention may include an acaricide selected from Phenisobromolate (isopropyl 4,4′-dibromobenzilate), Amitraz (3-methyl-1,5-bis(2,4-xylyl)-1,3,5-triazapenta-1,4-diene), and Fenpyroximate (tert-butyl=(E)-α-(1,3-dimethyl-5-phenoxypyrazol-4-ylmethyleneaminooxy)-p-toluate).

In the insecticide of the invention, the content of the agricultural chemical ingredient of agricultural chemical is preferably 5% by weight or less, more preferably 3% by weight or less, even more preferably 1% by weight or less, even more preferably 0.5% by weight or less, even more preferably 0.1% by weight or less, and even more preferably 0% by weight in the insecticide from the viewpoint of reduction of load on the natural environment and of production cost.

In addition, the formulation type of the insecticide of the invention may be any of an emulsion, a solution, a water dispersible powder, a granule, a powder, and a flowable formulation, and there is no limitation on the formulation type. Accordingly, another additive, for example, an emulsifier, a solvent, a dispersing agent, and a carrier may be contained in the insecticide of the invention in accordance with the formulation type thereof.

A chelating agent, a pH adjusting agent, an inorganic salt and a thickener may be added in the formulation of the insecticide of the invention if necessary.

Examples of the chelating agent usable in the invention may include an aminopolycarboxylic acid-based chelating agent, aromatic and aliphatic carboxylic acid-based chelating agents, an amino acid-based chelating agent, an ether polycarboxylic acid-based chelating agent, a phosphonic acid-based chelating agent (e.g., iminodimethyl phosphonic acid (IDP)), alkyl diphosphonic acid (ADPA), and the like), or dimethylglyoxime (DG), a hydroxyl carboxylic acid chelating agent, and a polyelectrolyte-based (oligomer-containing) chelating agent. These may be an acid as it is or in a form of a sodium salt, a potassium salt, an ammonium salt, or the like. The chelating agent is preferably blended at a proportion of 0.01 to 30 fold moles with respect to the component (B) in the insecticide.

As the aminopolycarboxylic acid-based chelating agent, anyone of the following compounds can be used:
a) an RNX₂ type compound;
b) an NX₃ type compound;
c) an R—NX—CH₂CH₂—NX—R-type compound;
d) an R—NX—CH₂CH₂—NX₂ type compound; and
e) an X₂N—R′—NX₂ type compound.
   In the formulas above, X represents —CH₂COOH or —CH₂CH₂COOH, R represents a hydrogen atom, an alkyl group, a hydroxyl group, a hydroxyalkyl group, or a substituent representing a known chelate compound of this kind, R′ represents an alkylene group, a cycloalkylene group, or a group representing a known chelate compound of this kind. Representative examples of these may include ethylenediaminetetraacetic acid (EDTA), cyclohexanediaminetetraacetic acid (CDTA), nitrilotriacetic acid (NTA), iminodiacetic acid (IDA), N-(2-hydroxyethyl)iminodiacetic acid (HIMDA), diethylenetriaminepentaacetic acid (DTPA), N-(2-hydroxyethyl)ethylenediaminetriacetic acid (EDTA-OH), and glycoletherdiaminetetraacetic acid (GEDTA), and a salt of these.

Examples of the aromatic and aliphatic carboxylic acid-based chelating agents usable in the invention may include oxalic acid, succinic acid, pyruvic acid, or anthranilic acid, and a salt of these. In addition, examples of the amino acid-based chelating agent usable in the invention may include glycine, serine, alanine, lysine, cystine, cysteine, ethionine, tyrosine, or methionine, and a salt and a derivative of these. In addition, examples of the hydroxy carboxylic acid-based chelating agent usable in the invention may include glycolic acid, malic acid, citric acid, gluconic acid, heptonic acid, acetic acid, and a salt of these. Moreover, examples of the ether polycarboxylic acid-based chelating agent usable in the invention may include a compound represented by the following Formula, a similar compound thereof, and a salt thereof (particularly, a Na salt thereof or the like).

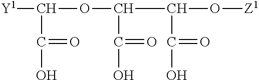

In the Formula, it is meant that:

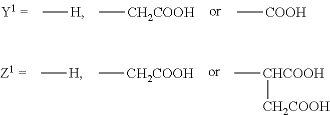

Examples of the polyelectrolyte-based (oligomer-containing) chelating agent usable in the invention may include an acrylic acid polymer, an anhydrous maleic acid polymer, an α-hydroxy acrylic acid polymer, an itaconic acid polymer, and a copolymer of these, and an epoxy succinic acid polymer.

Examples of the pH adjusting agent usable in the invention may include citric acid, phosphoric acid (pyrophosphoric acid), gluconic acid, or a salt of these.

Examples of the inorganic salt usable in the invention may include an inorganic mineral salt such as inorganic salt clay, talc, bentonite, zeolite, calcium carbonate, diatomaceous earth, and white carbon, and an inorganic ammonium salt such as ammonium sulfate, ammonium nitrate, ammonium phosphate, ammonium thiocyanate, ammonium chloride, and ammonium sulfamate.

In addition, as the thickener usable in the invention any of water-soluble natural, semisynthetic, and synthetic thickeners can be used, and specific examples thereof may include xanthan gum derived from microorganisms, Zanfuro, pectin derived from plants, gum arabic, and guar gum as the natural viscous substance, a methylated product, a carboxyalkylated product, and a hydroxyalkylated product of cellulose or starch derivative (including methyl cellulose, carboxymethyl cellulose, and hydroxymethyl cellulose), and sorbitol as the semisynthetic viscous substance, and a polyacrylate salt, a polymaleate salt, polyvinylpyrrolidone, and pentaerythritol ethylene oxide adduct as the synthetic viscous substance.

In a case in which the insecticide of the invention is sprayed on a harmful insect or a plant, a spray liquid containing the compound (A), the compound (B), and water can be used. The sum of the contents of the compound (A) and the compound (B) in the spray liquid is preferably from 30 to 50000 ppm, more preferably from 50 to 25000 ppm, even more preferably from 100 to 20000 ppm, even more preferably 300 to 15000 ppm, even more preferably from 500 to 12000 ppm, and even more preferably from 600 to 10000 ppm. When the content is the lower limit value or more, the wet spreading property of the droplets onto the body surface of harmful insect is favorable and thus a superior insecticidal effect is obtained. In addition, it is considered that when the content is the upper limit value or less, it is difficult for the droplets to flow down from the body surface of harmful insect, and thus the insecticidal effect is improved.

In a case in which the insecticide of the invention is sprayed on a plant, the insecticide can be sprayed at a proportion of preferably from 1 to 500 L/10 a, more preferably from 5 to 200 L/10 a, even more preferably from 5 to 100 L/10 a, even more preferably from 5 to 50 L/10 a, and even more preferably from 5 to 30 L/10 a when the sum of the contents of the compound (A) and the compound (B) in the spray liquid is in the range described above. When the application amount is the lower limit value or more, sufficient wettability can be obtained and thus more favorable insecticidal effect is obtained. In addition, when the application amount is the upper limit value or less, proper wetting can be realized and thus the droplets hardly flow down from the body surface of harmful insect.

The total amount of the compound (A) and compound (B) sprayed per unit area is in a range of preferably from 0.03 to 2500 g/10 a, more preferably from 0.1 to 250 g/10 a, and even more preferably from 1.0 to 100 g/10 a. The spray liquid is preferably used so that the total amount of the compound (A) and compound (B) sprayed per unit area is in this range.

Meanwhile, in a case in which the insecticide of the invention is sprayed, it is also preferable to use a small amount of spray liquid containing the compound (A) and the compound (B) at a high concentration. Specifically, the sum of the contents of the compound (A) and the compound (B) is from 500 to 100000 ppm, further from 1000 to 50000 ppm, and furthermore from 5000 to 25000 ppm, and the spray liquid containing water of the balance is preferably sprayed at a proportion of from 0.1 to 50 L/10 a, further from 0.5 to 25 L/10 a, furthermore from 1.0 to 10 L/10 a. In a case in which the amounts of the compound (A) and the compound (B) used per unit area is the same, a superior insecticidal effect and a superior acaricidal effect are obtained when sprayed in this method.

The method of exterminating a harmful insect of the invention includes a step of applying the insecticide of the invention to a harmful insect or a plant. The method of applying the insecticide to a harmful insect or a plant is not particularly limited, and includes a method to apply the insecticide of the invention directly to the harmful insect or leaf surface, stem, fruit or the like of plant as described above. The insecticide is preferably applied to the harmful insect and more preferably to both harmful insect and plant in order to exhibit effectively the effect (effect to blockade directly the spiracle of harmful insect) by the insecticide of the invention.

According to the invention, a method of exterminating a harmful insect, in which the insecticide of the invention is sprayed to a harmful insect and/or a plant, is provided. Moreover, a method of exterminating a harmful insect, in which the insecticide spray liquid containing the compound (A), the compound (B), and water is sprayed to and brought into contact with a harmful insect and/or a plant, is provided. The weight ratio of the compound (A) to the compound (B), the contents of the compounds (A) and (B), the application amount, and the like in the spray liquid can be appropriately selected from the ranges described above. The proportion of the compound (A) and the compound (B) among the components other than water in the spray liquid is preferably from 10 to 100% by weight, more preferably from 25 to 100% by weight, even more preferably from 50 to 100% by weight, even more preferably from 70 to 100% by weight, even more preferably from 90 to 100% by weight.

In the invention, the harmful insect includes a mite in addition to an insect such as an aphid for convenience.

In addition, examples of the harmful insect that is the target of the invention may include grasshopper, planthopper, fruit fly, moth, bug, aphid, scale insect, thrip, spider mite, gall mite, corn rootworm, slug, cutworm, and louse. Among these, one or two or more kinds selected from planthopper, aphid, and spider mite is preferable, one or two or more kinds selected from aphid and spider mite is more preferable, and aphid is even more preferable from the viewpoint of the improvement in the wet spreading property on the body surface of harmful insect and in the insecticidal effect.

Meanwhile, the compound (A) and the compound (B) contained in the insecticide of the invention can be separated by gas chromatography and detected by an FID detector even after preparation of the insecticide. For example, the presence or absence of the compound (A) and compound (B) in the insecticide can be quantitatively confirmed by diluting the insecticide with a proper solvent such as ethanol and measuring under the following conditions.
Equipment: Gas chromatography analysis system (Agilent Technologies 6850 Series II)
Column: DB5 ((5%-Phenyl)-Methylpolysiloxane)
Column size: 12 m×200 μm×0.33 μm,
Helium gas flow rate: 1.0 mL/min, pressure: 85.0 kPa, and
Column temperature conditions: (initial column temperature: 60° C., 2 min hold→10° C./min temperature rise→300° C., 14 min hold)

The invention includes the following aspects.
1. A method of exterminating a harmful insect, including a step of applying an agricultural and horticultural insecticide containing one or more kinds of compound (A) selected from (A1) to (A4) described above, preferably (A1) or (A3), even more preferably (A3), and one or more kinds of compound (B) selected from (B1) and (B2) described above, substantially not containing an agricultural chemical ingredient of an agricultural chemical, to a harmful insect or a plant, the agricultural chemical ingredient of agricultural chemical being selected from an agricultural chemical ingredient of each of a germicide, an insecticide, an acaricide, a herbicide, and a plant growth regulator.
2. The method of exterminating a harmful insect according to 1 described above, in which the weight ratio of the compound (A) to the compound (B) is 0.03 to 30 by (A)/(B).
3. The method of exterminating a harmful insect according to 1 or 2 described above, in which the agricultural and horticultural insecticide contains water and/or an organic solvent.
4. The use of agricultural and horticultural insecticide containing one or more kinds of compound (A) selected from (A1) to (A4) described above and one or more kinds of compound (B) selected from (B1) and (B2) described above but substantially not containing an agricultural chemical ingredient of agricultural chemical to kill a harmful insect, provided that the agricultural chemical ingredient of agricultural chemical is selected from the agricultural chemical ingredient of each of a germicide, an insecticide, an acaricide, a herbicide, and a plant growth regulator.
5. The method, use, or application according to any of 1 to 4 described above, in which the agricultural and horticultural insecticide of the invention does not contain an agricultural chemical ingredient of agricultural chemical of agricultural chemical ingredient of each of an insecticide and an acaricide other than the compound (A) and the compound (B).
6. The method, use, or application according to any of 1 to 5 described above, in which the insecticide of the invention is preferably sprayed directly to an insect or the leaf surface, stem, fruit, and the like of plant, more preferably applied to an insect, and even more preferably to both an insect and a plant.
7. The method, use, or application according to any of 1 to 6 described above, in which the insecticide of the invention is preferably sprayed to an insect and/or a plant, and the proportion of the compound (A) and the compound (B) among the components other than water in the spray liquid is preferably from 10 to 100% by weight, more preferably from 25 to 100% by weight, even more preferably from 50 to 100% by weight, even more preferably from 70 to 100% by weight, even more preferably from 90 to 100% by weight.
8. The method, use, or application according to any of 1 to 7 described above, in which the insecticide of the invention is preferably an emulsion, a solution, a water dispersible powder, a granule, a powder, or a flowable formulation, and the insecticide of the invention preferably contains a chelating agent, a pH adjusting agent, an inorganic salt or a thickener.
9. The method, use, or application according to any of 1 to 8 described above, in which the harmful insect is grasshopper, planthopper, fruit fly, moth, bug, aphid, scale insect, thrip, spider mite, gall mite, corn rootworm, slug, cutworm, or louse, preferably one or two or more kinds selected from planthopper, aphid, and spider mite, more preferably one or two or more kinds selected from aphid and spider mite, and even more preferably aphid.
10. The method, use, or application according to any of 1 to 9 described above, in which the compound (A) is (A1), the carbon number of the fatty acid is preferably 10 to 14 and more preferably 10 to 12, the fatty acid has even more preferably a linear or branched alkyl or alkenyl group and even more preferably a linear alkyl group, and the fatty acid is even more preferably caprylic acid, capric acid, lauric acid, myristic acid, or palmitic acid.
11. The method, use, or application according to any of 1 to 10 described above, in which the compound (A) is (A1), and the average added mole number of ethylene oxide is preferably 5 to 20 and more preferably 6 to 15, in addition, the ester is preferably a monoester.
12. The method, use, or application according to any of 1 to 11 described above, in which the compound (A) is (A2), the carbon number of the fatty acid is preferably 10 to 14 and more preferably 10 to 12, the fatty acid has even more preferably a linear or branched alkyl or alkenyl group and even more preferably a linear alkyl group, and the fatty acid is even more preferably caprylic acid, capric acid, lauric acid, myristic acid, or palmitic acid.
13. The method, use, or application according to any of 1 to 12 described above, in which the compound (A) is (A2), and the average added mole number of ethylene oxide is preferably 5 to 20 and more preferably 6 to 15, in addition, the degree of esterification is preferably 1.
14. The method, use, or application according to any of 1 to 13 described above, in which the compound (A) is (A3), (A3) is one or more kinds selected from a glycerol fatty acid ester and a polyglycerol fatty acid ester, the carbon number of the fatty acid is preferably 8 to 12, more preferably 10 to 12 and even more preferably 12, the fatty acid has preferably a linear or branched alkyl or alkenyl group and more preferably a linear alkyl group, and the fatty acid is even more preferably caprylic acid, capric acid, lauric acid, myristic acid, or palmitic acid.
15. The method, use, or application according to any of 1 to 14 described above, in which the compound (A) is (A3), and the average condensation degree of glycerol is preferably 1 to 2 and more preferably 1, in addition, the form of ester bond is preferably a monoester and a diester, and more preferably a monoester.
16. The method, use, or application according to any of 1 to 15 described above, in which the compound (A) is (A4), and R^{1a} is preferably an alkyl group having 10 to 14 carbon atoms, more preferably an alkyl group having 10 to 12 carbon atoms, and even more preferably an alkyl group having 12 carbon atoms.
17. The method, use, or application according to any of 1 to 16 described above, in which the compound (A) is (A4), and G is preferably ribose, arabinose, xylose, allose, altrose, glucose, mannose, fructose, gulose, idose, galactose, or talose, more preferably glucose, mannose, fructose, or galactose, and even more preferably glucose, and p is preferably a number of 1 to 5, and more preferably a number of 3 to 5.
18. The method, use, or application according to any of 1 to 17 described above, in which the compound (B) is (B1), and R^{1b} is preferably a linear or branched alkyl group having 8 to 12 carbon atoms, more preferably a linear or branched alkyl group having 8 to 10 carbon atoms, and even more preferably a linear alkyl group having 10 carbon atoms.
19. The method, use, or application according to any of 1 to 18 described above, in which the compound (B) is (B2), and R^{2c} is preferably a linear or branched alkyl or alkenyl group having 8 to 12 carbon atoms, more preferably a linear or branched alkyl or alkenyl group having 8 to 10 carbon atoms, and even more preferably a linear alkyl group having 8 to 10 carbon atoms, in addition, m is preferably 2 to 20, more preferably 2 to 18, even more preferably 2 to 16, even more preferably 2 to 12, and even more preferably 2 to 10, in addition, n is preferably 0 to 3, more preferably 0 to 2, even more preferably 0 to 1, and even more preferably 0.
20. The method, use, or application according to any of 1 to 19 described above, in which the compound (B) is (B2), and the ratio of m to the sum of m and n is preferably m/(m+n), and more preferably 0.5 to 1.0, even more preferably 0.6 to 1.0, even more preferably 0.7 to 1.0, even more preferably 0.8 to 1.0, even more preferably 0.9 to 1.0, and even more preferably 1.0.
21. The method, use, or application according to any of 1 to 20 described above, in which the compound (B) is (B2), and R^{2b} is preferably a hydrogen atom.
22. The method, use, or application according to any of 1 to 20 described above, in which the compound (B) is (B2), and, when PO and EO coexist, the arrangement of PO and EO is preferably a block arrangement, and is more preferably a block arrangement having the order of PO.EO to R^{2c}O—.
23. The method, use, or application according to any of 1 to 22 described above, in which the weight ratio of the compound (A) to the compound (B) is preferably 0.03 to 30, more preferably 0.05 to 20, even more preferably 0.1 to 10, even more preferably 0.1 to 8, even more preferably 0.3 to 8, and even more preferably 0.5 to 2 by (A)/(B).
24. The method, use, or application according to any of 1 to 23 described above, in which the agricultural and horticultural insecticide of the invention contains the compound (A) and the compound (B) at more preferably 5% by weight or more, even more preferably 10% by weight or more, even more preferably 20% by weight or more, even more preferably 40% by weight or more, even more preferably 60% by weight or more, even more preferably 80% by weight or more, and even more preferably 90% by weight or more in total.
25. The method, use, or application according to any of 1 to 24 described above, in which the agricultural and horticultural insecticide of the invention preferably contains a nonionic surfactant, an anionic surfactant, a cationic surfactant, an amphoteric surfactant, or a mixture thereof other than the compound (A) and the compound (B), and the total proportion of the compound (A) and the compound (B) contained in the total surfactant of the insecticide is preferably 50% by weight or more, more preferably 70% by weight or more, and even more preferably 90% by weight or more.
26. The method, use, or application according to any of 1 to 25 described above, in which the agricultural and horticultural insecticide of the invention contains preferably isobutanol, isopropanol, ethanol, diethylene glycol, ethyl lactate, butyl cellosolve, polyethylene glycol (weight average molecular weight of 200 to 400), dimethyl sulfoxide, N-butyl carbitol, 1,3-butylene glycol, dipropylene glycol 2-(2-methoxyethoxy) ethanol, or ethyl carbitol, more preferably ethyl lactate or diethylene glycol, and even more preferably diethylene glycol.
27. The method, use, or application according to any of 1 to 26 described above, in which the amount of the compound (A) and the compound (B) contained in the insecticide is preferably 50% by weight or more, more preferably 70% by weight or more, and even more preferably 90% by weight or more, and the content of the water and/or the organic solvent is preferably less than 50% by weight, more preferably from 1 to 50% by weight and even more preferably from 5 to 30% by weight in the insecticide in a case in which the insecticide of the invention contains water and/or an organic solvent.
28. The method, use, or application according to any of 1 to 3 described above, in which the content of the agricultural chemical ingredient of agricultural chemical is 5% by weight or less, preferably 3% by weight or less, more preferably 1% by weight or less, even more preferably 0.5% by weight or less, even more preferably 0.1% by weight or less, and even more preferably 0% by weight in the insecticide.
29. The method, use, or application according to any of 1 to 28 described above, in which the insecticide of the invention preferably contains a small content of (i) hydrogen peroxide and a compound that releases hydrogen peroxide in water and (ii) hypochlorous acid, a hypochlorite salt, and a compound that releases hypochlorous acid in water, more preferably 0.1% by weight or less, even more preferably 0.01% by weight or less, as hypochlorous acid or hydrogen peroxide in the insecticide and it is even more preferable that the insecticide has no content.
30. The method, use, or application according to any of 1 to 29 described above, in which the agricultural and horticultural insecticide of the invention does not contain any agricultural chemical ingredient of agricultural chemical selected from the agricultural chemical ingredient of each of a germicide, an insecticide, an acaricide, a herbicide, and a plant growth regulator other than the compound (A) and the compound (B).
31. The method, use, or application according to any of 1 to 30 described above, in which the agricultural and horticultural insecticide of the invention does not contain any agricultural chemical ingredient of agricultural chemical selected from the agricultural chemical ingredient of each of a germicide, an insecticide, an acaricide, a herbicide, and a plant growth regulator other than the compound (A) and the compound (B).

### EXAMPLES

The following Examples will describe the invention in reference to working of the invention. The Examples illustrate the invention as examples and are not intended to limit the invention.

### Examples 1 to 22 and Comparative Examples 1 to 22

Compound (A), compound (B), and the comparative compound used in the following Examples and Comparative Examples are listed in Tables 1 and 2. In addition, commercial insecticides (C) used as the comparative product are listed in Table 3.

The insecticide of Table 4 [the insecticide occupied at 100% by weight by the compounds listed in Tables 1 and 2] was prepared using the compounds listed in Tables 1 and 2 in the combination indicated in Table 4, and then subjected to the insecticidal test and the acaricidal test by the following method.

The compounds other than A-4, A-5, A-6, and A′-3 in Table 1, and the compounds other than B1′-1, B1′-2, and B1′-3 in Table 2 are manufactured by Kao Corporation, A-4, A-5, A-6, and A′-3 in Table 1 are manufactured by Taiyo Kagaku Co., Ltd., and B1′-1, B1′-2, and B1′-3 are manufactured by Wako Pure Chemical Industries, Ltd. Meanwhile, in Table 4, the compounds that do not correspond to the compound (A) or the compound (B) are also listed in the individual fields for convenience. In addition, in Table 4, the “concentration of (A)+(B)” with regard to commercial insecticides is a concentration of each commercial product in a spraying liquid, prepared on the basis of the standard use amount of the product.

### Examples 23 to 46 and Comparative Example 23 to 38

The compound (A), the compound (B), and the comparative compound used in the following Examples and Comparative Examples are listed in Tables 1 and 5. In addition, the commercial insecticides used as the comparative product are listed in Table 3.

The insecticide of Table 6 [the insecticide occupied at 100% by weight by the compounds listed in Tables 1 and 5] was prepared using the compounds listed in Tables 1 and 5 in the combination indicated in Table 6, and then subjected to the insecticidal test and the acaricidal test by the following method.

The compounds other than A-4, A-5, A-6, and A′-3 in Table 1, and all of the compounds other than B2′-3 and B2′-4, in Table 5 are manufactured by Kao Corporation, A-4, A-5, A-6, and A′-3 in Table 1 are manufactured by Taiyo Kagaku Co., Ltd., and B2′-3 and B2′-4 are manufactured by Wako Pure Chemical Industries, Ltd. Meanwhile, in Table 6, the compounds that do not correspond to the compound (A) or the compound (B) are also listed in the individual fields for convenience. In addition, in Table 4, the “concentration of (A)+(B)” with regard to the commercial insecticides is a concentration of each commercial product in a spraying liquid, prepared on the basis of the standard use amount of the product.

### [Insecticidal Test I]

A seedling of rice plant was grown in a 12 cm pot until the plant height reaches 15 cm. Ten individuals of planthopper, which had passed 3 to 5 days after emergence, were applied per one rice plant. The rice plant was trial-cultured for three repetitions. With 1 L of water, an insecticide was mixed in such an amount that the concentration of each of the compounds at the time of spraying was the amount indicated in Table 4, thereby preparing the spray liquid of insecticide. This spray liquid was sprayed on the leaf surface of the seedling of rice plant attached with planthoppers in the application amount indicated in Table 4. After air drying, the seedling of rice plant sprayed with the spray liquid was covered with a wire gauze cylinder. Three days later, the number of surviving insects was measured, and the insect killing rate (indicated as the “insect killing rate I” in Table 4) was calculated by the following equation. It means that the effect of agricultural chemical (insecticidal effect) is high as the value of the insect killing rate is high.

Insect killing rate (%)=(the number of surviving insects in non-treated area−the number of surviving insects in treated area)/the number of surviving insects in non-treated area×100

From the results of Table 4 and Table 6, it is confirmed that the insecticide of the invention exhibits an excellent insecticidal effect to planthopper.

### [Insecticidal Test II]

A cabbage seedling was grown in a 12 cm pot until to be a ten-leaf stage. The leaf of cabbage was cut and placed in a petri dish with a diameter of 9 cm, and 15 individuals of cotton aphid were trial cultured for three repetitions. With 1 L of water, the insecticide was mixed in such an amount that the concentration of each of the compounds at the time of spraying was the amount indicated in Table 4, thereby preparing the spray liquid of insecticide. This spray liquid was sprayed to the leaf surface of the cabbage attached with cotton aphids in the application amount indicated in Table 4. After air drying, the petri dish was covered with a lid, and an oxygen permeable seal was sealed around the petri dish so as to prevent the escape of the aphid therefrom. One day later, the number of surviving insects was measured, and the insect killing rate (indicated as the “insect killing rate II” in Table 4) was calculated by the following equation. It means that the effect of agricultural chemical (insecticidal effect) is high as the value of the insect killing rate is high.

Insect killing rate (%)=(the number of surviving insects in non-treated area−the number of surviving insects in treated area)/the number of surviving insects in non-treated area×100

From the results of Table 4 and Table 6, it is confirmed that the insecticide of the invention exhibits an excellent insecticidal effect to cotton aphid.

### [Acaricidal Test]

A kidney bean was grown in a 12 cm pot until to be a 5-leaf stage. Thirty individuals of Kanzawa spider mite per one plant were implanted for three repetitions. To 1 L of water, the insecticide was mixed such that the concentration of each of the compounds at the time of spraying becomes the amount indicated in Table 4 and Table 6, thereby preparing the spray liquid of insecticide. This spray liquid was sprayed on the leaf surface of the kidney bean attached with Kanzawa spider mites in the application amount indicated in Table 4 and Table 6. After air drying, the kidney bean sprayed with the spray liquid was covered with a wire gauze cylinder. Three days later, the number of surviving mites was measured, and the mite killing rate was calculated by the following equation. It means that the effect of agricultural chemical (acaricidal effect) is high as the value of the mite killing rate is high.

Mite killing rate (%)=(the number of surviving mites in non-treated area−the number of surviving mites in treated area)/the number of surviving mites in non-treated area×100

From the results of Table 4 and Table 6, it is confirmed that the insecticide of the invention exhibits an excellent insecticidal effect with respect to Kanzawa spider mite.

TABLE 1

| | For- | | | |
|---|---|---|---|---|
| | mula | Symbol | Compound | Manufacturer |
| Compound | (A1) | A-1 | Polyoxyethylene (12) monolauric | Kao corporation |
| (A) | | | acid ester | |
| | (A2) | A-2 | Polyoxyethylene (6) sorbitan | Kao corporation |
| | | | monolauric acid ester | |
| | | A-3 | Polyoxyethylene (20) sorbitan | Kao corporation |
| | | | monolauric acid ester | |
| | (A3) | A-4 | Monolauric acid diglycerine | Taiyo Kagaku Co., Ltd |
| | | A-5 | Monocapric acid monoglycerine | Taiyo Kagaku Co., Ltd |
| | | A-6 | Monocapric acid monoglycerine | Taiyo Kagaku Co., Ltd |
| | (A4) | A-7 | Decyl glucoside [p = 1.3 in | Kao corporation |
| | | | Formula (A4)] | |
| | | A-8 | Lauryl glucoside [p = 4.6 in | Kao corporation |
| | | | Formula (A5)] | |
| Comparative | — | A′-1 | Polyoxyethylene (9) monooleic | Kao corporation |
| compound | | | acid ester | |
| | — | A′-2 | Polyoxyethylene (6) sorbitan | Kao corporation |
| | | | monooleic acid ester | |
| | — | A′-3 | Monooleic acid diglycerine | Taiyo Kagaku Co., Ltd |
| | — | A′-4 | Sorbitan monooleic acid ester | Kao corporation |

TABLE 2

| | For- | | | |
|---|---|---|---|---|
| | mula | Symbol | Compound | Manufacturer |
| Compound | (B1) | B1-1 | Octyl alcohol | Kao corporation |
| (B) | | B1-2 | Decyl alcohol | Kao corporation |
| | | B1-3 | Lauryl alcohol | Kao corporation |
| | | B1-4 | Myristyl alcohol | Kao corporation |
| Comparative | — | B1′-1 | Metyl alcohol | Wako Pure Chemical |
| compound | | | | Industries, Ltd. |
| | — | B1′-2 | Propyl alcohol | Wako Pure Chemical |
| | | | | Industries, Ltd. |
| | — | B1′-3 | Butyl alcohol | Wako Pure Chemical |
| | | | | Industries, Ltd. |
| | — | B1′-4 | Oleyl alchol | New Japan Chemical |
| | | | | Co., Ltd. |
| | — | B1′-5 | Stearyl alcohol | Kao corporation |

TABLE 3

| | Symbol | Product name | Manufacturer | Major component |
|---|---|---|---|---|
| Commercial | C-1 | Ranneto 45 | Shelling agency | S-methyl-N-[(methylcarbamoyl)- |
| insecticide | | water dispersible | | oxy]-thioacetimidate |
| | | powder | | |
| | C-2 | Mushirappu | MARUWA Biochemical | Sorbitan fatty acid ester |
| | | | Co., Ltd. | |
| | C-3 | Nenchaku-kun | Sumitomo chemical | Starch |
| | | | garden products Inc. | |
| | C-4 | Sankurisutaru | SANKEI CHEMICAL | Fatty acid glyceride |
| | | | Co., Ltd. | (carbon number of 8 to 10) |
| | C-5 | Akaritacchi | ISHIHARA SANGYO | Propylene glycol mono |
| | | | KAIHSA, LTD. | fatty acif ester |

TABLE 4

| | | | | | | Insecticide spray | | Result of evaluation | | |
|---|---|---|---|---|---|---|---|---|---|---|
| | | | | | | solution | | Insect | Insect | Mite |
| | | | | | (A)/(B) | | (A) + (B) | killing | killing | killing |
| | | Compound | Compound | Commercial | weight | Application | concentration | rate I | rate II | rate |
| | | (A) | (B) | insecticide | ratio | amount | (ppm) | (%) | (%) | (%) |
| Example | 1 | A-1 | B1-2 | — | 1 | 100 L/10 a | 1000 | 81 | 90 | 77 |
| | 2 | A-2 | B1-2 | — | 1 | 100 L/10 a | 1000 | 79 | 88 | 74 |
| | 3 | A-3 | B1-2 | — | 1 | 100 L/10 a | 1000 | 78 | 88 | 72 |
| | 4 | A-4 | B1-2 | — | 1 | 100 L/10 a | 1000 | 81 | 92 | 76 |
| | 5 | A-5 | B1-2 | — | 1 | 100 L/10 a | 1000 | 80 | 90 | 76 |
| | 6 | A-6 | B1-2 | — | 1 | 100 L/10 a | 1000 | 85 | 94 | 82 |
| | 7 | A-7 | B1-2 | — | 1 | 100 L/10 a | 1000 | 77 | 86 | 72 |
| | 8 | A-8 | B1-2 | — | 1 | 100 L/10 a | 1000 | 79 | 88 | 74 |
| | 9 | A-6 | B1-1 | — | 1 | 100 L/10 a | 1000 | 83 | 92 | 79 |
| | 10 | A-6 | B1-3 | — | 1 | 100 L/10 a | 1000 | 84 | 92 | 80 |
| | 11 | A-6 | B1-4 | — | 1 | 100 L/10 a | 1000 | 77 | 86 | 71 |
| | 12 | A-6 | B1-2 | — | 1 | 8 L/10 a | 12500 | 92 | 100 | 90 |
| | 13 | A-6 | B1-2 | — | 1 | 25 L/10 a | 4000 | 89 | 98 | 86 |
| | 14 | A-6 | B1-2 | — | 1 | 50 L/10 a | 2000 | 86 | 96 | 83 |
| | 15 | A-6 | B1-2 | — | 1 | 200 L/10 a | 500 | 76 | 86 | 71 |
| | 16 | A-6 | B1-2 | — | 0.2 | 100 L/10 a | 1000 | 74 | 84 | 70 |
| | 17 | A-6 | B1-2 | — | 0.5 | 100 L/10 a | 1000 | 80 | 90 | 76 |
| | 18 | A-6 | B1-2 | — | 2 | 100 L/10 a | 1000 | 84 | 93 | 79 |
| | 19 | A-6 | B1-2 | — | 5 | 100 L/10 a | 1000 | 80 | 88 | 75 |
| | 20 | A-6 | B1-2 | — | 1 | 100 L/10 a | 200 | 73 | 82 | 68 |
| | 21 | A-6 | B1-2 | — | 1 | 100 L/10 a | 500 | 81 | 90 | 76 |
| | 22 | A-6 | B1-2 | — | 1 | 100 L/10 a | 5000 | 92 | 100 | 87 |
| Comparative | 1 | Non-treated | | — | — | — | — | 0 | 0 | 0 |
| example | 2 | — | — | C-1 | — | 100 L/10 a | 1000 | 59 | 70 | 55 |
| | 3 | — | — | C-2 | — | 100 L/10 a | 2000 | 51 | 61 | 46 |
| | 4 | — | — | C-3 | — | 100 L/10 a | 10000 | 44 | 56 | 39 |
| | 5 | — | — | C-4 | — | 100 L/10 a | 3333 | 48 | 60 | 42 |
| | 6 | — | — | C-5 | — | 100 L/10 a | 1000 | 45 | 51 | 39 |
| | 7 | A-6 | — | — | — | 100 L/10 a | 1000 | 46 | 57 | 40 |
| | 8 | A-6 | B1′-1 | — | 1 | 100 L/10 a | 1000 | 47 | 59 | 41 |
| | 9 | A-6 | B1′-2 | — | 1 | 100 L/10 a | 1000 | 49 | 61 | 42 |
| | 10 | A-6 | B1′-3 | — | 1 | 100 L/10 a | 1000 | 50 | 60 | 43 |
| | 11 | A-6 | B1′-4 | — | 1 | 100 L/10 a | 1000 | 48 | 59 | 43 |
| | 12 | A-6 | B1′-5 | — | 1 | 100 L/10 a | 1000 | 49 | 61 | 44 |
| | 13 | — | B1-1 | — | 0 | 100 L/10 a | 1000 | 22 | 30 | 18 |
| | 14 | A′-1 | B1-1 | — | 1 | 100 L/10 a | 1000 | 46 | 55 | 41 |
| | 15 | A′-2 | B1-1 | — | 1 | 100 L/10 a | 1000 | 46 | 56 | 42 |
| | 16 | A′-3 | B1-1 | — | 1 | 100 L/10 a | 1000 | 45 | 54 | 41 |
| | 17 | A′-4 | B1-1 | — | 1 | 100 L/10 a | 1000 | 44 | 56 | 40 |
| | 18 | A-6 | — | C-1 | 1*¹ | 100 L/10 a | 1000 | 62 | 71 | 58 |
| | 19 | — | B1-2 | C-1 | 1*² | 100 L/10 a | 1000 | 60 | 70 | 56 |
| | 20 | — | B1-2 | C-3 | 1*² | 100 L/10 a | 1000 | 47 | 60 | 43 |
| | 21 | A-6 | — | — | — | 100 L/10 a | 2000 | 47 | 58 | 41 |
| | 22 | — | B1-1 | — | 0 | 100 L/10 a | 2000 | 24 | 34 | 22 |

*¹Weight ratio of compound (A)/commercial insecticide (as it is present)
*²Weight ratio of compound (B)/commercial insecticide (as it is present)

### [Observation of Spiracle Blockage]

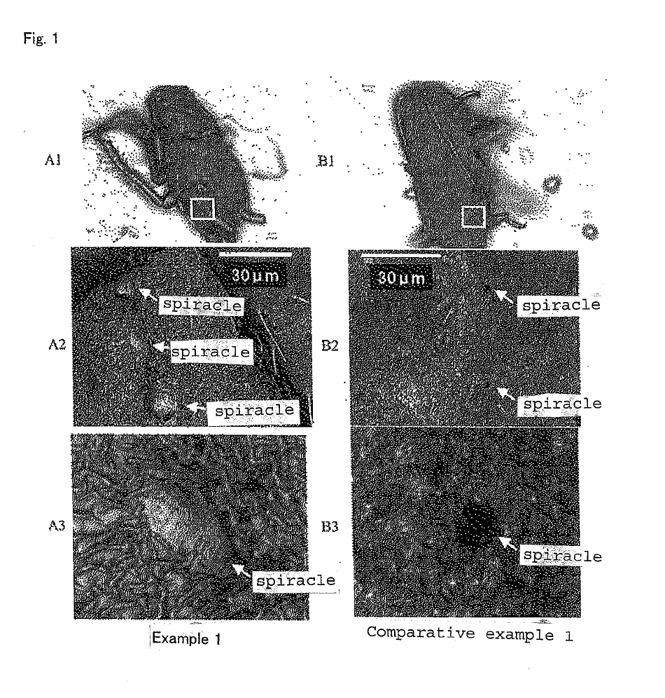

The spiracle state of the cotton aphid of Comparative Example 1 (non-treated area) and Example 1 after the insecticidal test II was observed by a laser microscope (KEYENCE VK-9700). The result is illustrated in FIG. 1. The spiracles were not blockaded in Comparative Example 1 (B2 and B3 in FIG. 1), but it was observed that the spiracle of cotton aphid was blockaded (A2 and A3 in FIG. 1) according to the insecticide of Example 1. Meanwhile, in FIG. 1, A1 to A3 are the result of Example 1, and B1 to B3 are the result of Comparative Example 1. The portion surrounded by a white frame is a part of the spiracles of cotton aphid in A1 and B1, A2 and B2 are the enlarged views thereof, and A3 and B3 are further enlarged views thereof.

TABLE 5

| | | | | Structure in the formula (B2) | | | | |
|---|---|---|---|---|---|---|---|---|
| | Formula | Symbol | Compound | R^{2c} | m | n | m/(m + n) | R^{2b} |
| Compound (B) | (B2) | B2-1 | Polyoxypropylene(3) | Hexyl group | 3 | 0 | 1 | Hydrogen atom |
| | | | hexyl ether | | | | | |
| | | B2-2 | Polyoxypropylene(3) | Octyl group | 3 | 0 | 1 | Hydrogen atom |
| | | | octyl ether | | | | | |
| | | B2-3 | Polyoxypropylene (20) | Octyl group | 20 | 0 | 1 | Hydrogen atom |
| | | | octyl ether | | | | | |
| | | B2-4 | Polyoxypropylene(3) | Decyl group | 3 | 0 | 1 | Hydrogen atom |
| | | | decyl ether | | | | | |
| | | B2-5 | Polyoxypropylene(3) | Lauryl group | 3 | 0 | 1 | Hydrogen atom |
| | | | lauryl ether | | | | | |
| | | B2-6 | Polyoxypropylene(6) | 2-ethylhexyl | 6 | 3 | 0.67 | Hydrogen atom |
| | | | polyoxyethylene(3) -2- | group | | | | |
| | | | ethylhexyl ether | | | | | |
| Comparative | | B2′-1 | Polyoxypropylene(3) | Butyl group | 3 | 0 | 1 | Hydrogen atom |
| compound | | | butyl ether | | | | | |
| | — | B2′-2 | Polyoxypropylene(30) | Octyl group | 30 | 0 | 1 | Hydrogen atom |
| | | | octyl ether | | | | | |
| | — | B2′-3 | Polypropylene glycol | Hydrogen atom | 5 | 0 | 1 | Hydrogen atom |
| | | | (Weight average mo- | | | | | |
| | | | lecular weight of 300) | | | | | |
| | — | B2′-4 | Polyethylene glycol | Hydrogen atom | 0 | 25 | 0 | Hydrogen atom |
| | | | (Weight average mo- | | | | | |
| | | | lecular weight of 1000) | | | | | |

Products manufactured by Kao Corporation were used for all of B2-1 to B2-6, and B2-1′ and B2-2′.

TABLE 6

| | | | | | | | | Result of evaluation | | |
|---|---|---|---|---|---|---|---|---|---|---|
| | | | | | | | | Insect | Insect | Mite |
| | | | | | (A)/(B) | Incecticide spray solution | | killing | killing | killing |
| | | Compound | Compound | Commercial | weight | Application | (A) + (B) | rate I | rate II | rate |
| | | (A) | (B) | insecticide | ratio | amount | (ppm) | (%) | (%) | (%) |
| Example | 1 | A-1 | B2-2 | — | 1 | 100 L/10 a | 1000 | 78 | 87 | 74 |
| | 2 | A-2 | B2-2 | — | 1 | 100 L/10 a | 1000 | 76 | 85 | 71 |
| | 3 | A-3 | B2-2 | — | 1 | 100 L/10 a | 1000 | 75 | 85 | 69 |
| | 4 | A-4 | B2-2 | — | 1 | 100 L/10 a | 1000 | 78 | 89 | 73 |
| | 5 | A-5 | B2-2 | — | 1 | 100 L/10 a | 1000 | 77 | 87 | 73 |
| | 6 | A-7 | B2-2 | — | 1 | 100 L/10 a | 1000 | 74 | 83 | 69 |
| | 7 | A-8 | B2-2 | — | 1 | 100 L/10 a | 1000 | 76 | 85 | 71 |
| | 8 | A-6 | B2-1 | — | 1 | 100 L/10 a | 1000 | 78 | 88 | 73 |
| | 9 | A-6 | B2-2 | — | 1 | 100 L/10 a | 1000 | 81 | 90 | 76 |
| | 10 | A-6 | B2-3 | — | 1 | 100 L/10 a | 1000 | 76 | 86 | 71 |
| | 11 | A-6 | B2-4 | — | 1 | 100 L/10 a | 1000 | 76 | 86 | 71 |
| | 12 | A-6 | B2-5 | — | 1 | 100 L/10 a | 1000 | 73 | 84 | 68 |
| | 13 | A-6 | B2-6 | — | 1 | 100 L/10 a | 1000 | 80 | 90 | 75 |
| | 14 | A-6 | B2-2 | — | 1 | 8 L/10 a | 12500 | 88 | 96 | 86 |
| | 15 | A-6 | B2-2 | — | 1 | 25 L/10 a | 4000 | 85 | 94 | 82 |
| | 16 | A-6 | B2-2 | — | 1 | 50 L/10 a | 2000 | 82 | 92 | 79 |
| | 17 | A-6 | B2-2 | — | 1 | 200 L/10 a | 500 | 72 | 82 | 67 |
| | 18 | A-6 | B2-2 | — | 0.2 | 100 L/10 a | 1000 | 70 | 80 | 66 |
| | 19 | A-6 | B2-2 | — | 0.5 | 100 L/10 a | 1000 | 76 | 86 | 72 |
| | 20 | A-6 | B2-2 | — | 2 | 100 L/10 a | 1000 | 80 | 89 | 75 |
| | 21 | A-6 | B2-2 | — | 5 | 100 L/10 a | 1000 | 76 | 84 | 71 |
| | 22 | A-6 | B2-2 | — | 1 | 100 L/10 a | 200 | 69 | 78 | 64 |
| | 23 | A-6 | B2-2 | — | 1 | 100 L/10 a | 500 | 77 | 86 | 72 |
| | 24 | A-6 | B2-2 | — | 1 | 100 L/10 a | 5000 | 88 | 96 | 83 |
| Comparative | 1 | Non-treated | | — | — | — | — | 0 | 0 | 0 |
| example | 2 | — | — | C-1 | — | 100 L/10 a | 1000 | 59 | 70 | 55 |
| | 3 | — | — | C-2 | — | 100 L/10 a | 2000 | 51 | 61 | 46 |
| | 4 | — | — | C-3 | — | 100 L/10 a | 10000 | 44 | 56 | 39 |
| | 5 | — | — | C-4 | — | 100 L/10 a | 3333 | 48 | 60 | 42 |
| | 6 | — | — | C-5 | — | 100 L/10 a | 1000 | 45 | 51 | 39 |
| | 7 | A-6 | — | — | — | 100 L/10 a | 1000 | 46 | 57 | 40 |
| | 8 | A-6 | B2′-1 | — | 1 | 100 L/10 a | 1000 | 48 | 60 | 42 |
| | 9 | A-6 | B2′-2 | — | 1 | 100 L/10 a | 1000 | 50 | 62 | 43 |
| | 10 | A-6 | B2′-3 | — | 1 | 100 L/10 a | 1000 | 51 | 61 | 44 |
| | 11 | A-6 | B2′-4 | — | 1 | 100 L/10 a | 1000 | 49 | 60 | 44 |
| | 12 | — | B2-2 | — | 0 | 100 L/10 a | 1000 | 22 | 30 | 18 |
| | 13 | A′-1 | B2-2 | — | 1 | 100 L/10 a | 1000 | 46 | 55 | 41 |
| | 14 | A′-2 | B2-2 | — | 1 | 100 L/10 a | 1000 | 46 | 56 | 42 |
| | 15 | A′-3 | B2-2 | — | 1 | 100 L/10 a | 1000 | 45 | 54 | 41 |
| | 16 | A′-4 | B2-2 | — | 1 | 100 L/10 a | 1000 | 44 | 56 | 40 |
| | 17 | A-6 | — | C-1 | 1*¹ | 100 L/10 a | 1000 | 62 | 71 | 58 |
| | 18 | — | B2-2 | C-1 | 1*² | 100 L/10 a | 1000 | 60 | 69 | 57 |
| | 19 | — | B2-2 | C-3 | 1*² | 100 L/10 a | 1000 | 48 | 59 | 43 |
| | 20 | A-6 | — | — | — | 100 L/10 a | 2000 | 47 | 58 | 41 |
| | 21 | — | B2-2 | — | 0 | 100 L/10 a | 2000 | 24 | 33 | 21 |

*¹Weight ratio of compound (A)/commercial insecticide (as it is present)
*²Weight ratio of compound (B)/commercial insecticide (as it is present)

1. A method of exterminating a harmful insect, comprising applying an agricultural and horticultural insecticide comprising at least one compound (A) selected from the group consisting of the following (A1), (A3) and (A4) and at least one compound (B) selected from the group consisting of the following (B1) and (B2), provided that an agricultural chemical ingredient of an agricultural chemical is not substantially contained, to a harmful insect or a plant,
wherein
the agricultural chemical ingredient of an agricultural chemical is selected from the group consisting of agricultural chemical ingredients of a germicide, an insecticide, an acaricide, a herbicide and a plant growth regulator;
(A1): a polyoxyethylene fatty acid ester, provided that the carbon number of the fatty acid is 8 to 16 and an average added mole number of ethylene oxide is 5 to 40;
(A3): a (poly)glycerol fatty acid ester, provided that the carbon number of the fatty acid is 8 to 16 and an average condensation degree of glycerol is 1 to 3; and
(A4): an alkyl saccharide represented by the following Formula (A4):
R^{1a}—O-(G)ₚ (A4)
in Formula (A4), R^{1a} represents an alkyl group having 8 to 16 carbon atoms, G represents a reducing sugar having 5 to 6 carbon atoms, and p is a number of 1 to 10;
(B1): a compound represented by (B1):
R^{1b}—OH (B1)
in Formula (B1), R^{1b} represents a linear or branched alkyl group having 8 to 14 carbon atoms; and
(B2): a compound represented by (B2):
R^{2c}O—[(PO)ₘ/(EO)ₙ]—R^{2b} (B2)
in Formula (B2), R^{2c} represents a linear or branched alkyl or alkenyl group having 6 to 12 carbon atoms, PO represents a propyleneoxy group, EO represents an ethyleneoxy group, m is a number of 1 to 25 representing an average added mole number of propyleneoxy group, n is a number of 0 to 4 representing an average added mole number of ethyleneoxy group, R^{2b} represents a hydrogen atom or a methyl group, and “/” means that arrangement of PO and EO may be random or block.

2. The method of exterminating a harmful insect according to claim 1, wherein a content of the agricultural chemical ingredient of an agricultural chemical is 0% by weight in the agricultural and horticultural insecticide.

3. The method of exterminating a harmful insect according to claim 1, wherein a weight ratio of the compound (A) to the compound (B) is 0.03 to 30 in terms of (A)/(B).

4. The method of exterminating a harmful insect according to claim 1, wherein the agricultural and horticultural insecticide comprises water and/or an organic solvent.

5-8. (canceled)

9. The method of exterminating a harmful insect according to claim 1, wherein the insecticide is sprayed directly to the insect or leaf surface, stem or fruit of the plant.

10. The method of exterminating a harmful insect according to claim 1, wherein the insecticide is applied to both harmful insect and plant.

11. The method of exterminating a harmful insect according to claim 1, wherein the fatty acid of the compound (A1) has 10 to 12 carbon atoms, the fatty acid of the compound (A3) has 10 to 12 carbon atoms and the alkyl group of the compound (A4) has 10 to 12 carbon atoms.

12. The method of exterminating a harmful insect according to claim 1, wherein the compound (A) is (A3) and the compound (B) is (B1).

13. The method of exterminating a harmful insect according to claim 1, wherein compound (A3) is at least one selected from the group consisting of a glycerol fatty acid ester and a polyglycerol fatty acid ester.

14. The method of exterminating a harmful insect according to claim 1, wherein the fatty acid of compound (A3) is selected from the group consisting of caprylic acid, capric acid, lauric acid, myristic acid and palmitic acid.

15. The method of exterminating a harmful insect according to claim 1, wherein R^{1b} of compound (B1) is a linear or branched alkyl group having 8 to 10 carbon atoms and R^{2c} of compound (B2) is a linear or branched alkyl or alkenyl group having 8 to 10 carbon atoms.

16. The method of exterminating a harmful insect according to claim 1, wherein R^{1b} of compound (B1) is a linear alkyl group having 8 to 12 carbon atoms.

17. The method of exterminating a harmful insect according to claim 1, wherein R^{1b} of compound (B1) is a linear alkyl group having 10 carbon atoms.

18. The method of exterminating a harmful insect according to claim 1, wherein m in compound (B2) is a number of 2 to 10.

19. The method of exterminating a harmful insect according to claim 1, wherein n of compound (B2) is a number of 0 to 1.

20. The method of exterminating a harmful insect according to claim 1, wherein the arrangement of PO and EO is a block arrangement.

21. The method of exterminating a harmful insect according to claim 1, wherein the weight ratio of the compound (A) to the compound (B) is 0.5 to 2 by (A)/(B).

22. The method of exterminating a harmful insect according to claim 1, wherein the agricultural and horticultural insecticide comprises a nonionic surfactant, an anionic surfactant, a cationic surfactant, an amphoteric surfactant or a mixture thereof other than the compound (A) and the compound (B).

23. The method of exterminating a harmful insect according to claim 1, wherein the content of the water and the organic solvent is from 5 to 30% by weight in the insecticide.

24. The method of exterminating a harmful insect according to claim 1, wherein the organic solvent is at least one selected from the group consisting of isobutanol, isopropanol, ethanol, diethylene glycol, ethyl lactate, butyl cellosolve, polyethylene glycol (weight average molecular weight of 200 to 400), dimethyl sulfoxide, N-butyl carbitol, 1,3-butylene glycol, dipropylene glycol 2-(2-methoxyethoxy) ethanol and ethyl carbitol.
